(19) United States
(12) Patent Application Publication
(10) Pub. No.: US 2012/0055335 A1
(43) Pub. Date: Mar. 8, 2012

(54) DRAIN LIQUID RELIEF SYSTEM FOR A SUBSEA COMPRESSOR AND A METHOD FOR DRAINING THE SUBSEA COMPRESSOR

(76) Inventors: Gesinus Mateman, Hengelo (NL); Wolfgang Zacharias, Dulsburg (DE)

(21) Appl. No.: 13/203,332

(22) PCT Filed: Feb. 25, 2010
(86) PCT No.: PCT/EP2010/052414

§ 371 Date: Nov. 8, 2011

(30) Foreign Application Priority Data
Mar. 10, 2009 (EP) 09003448.9

(51) Int. Cl. B01D 53/14; E21B 43/36; B01D 47/00

(52) U.S. Cl. 95/153; 95/229; 166/357; 96/235

(57) ABSTRACT

A drain liquid relief system for a subsea compressor is provided. The system includes a suction scrubber a drain storage tank for collecting drain liquid contaminating the compressor flow in the drain storage tank. The system further includes an intermittently pressurizing device and a suction line connected to the bottom of the drain storage tank. The suction scrubber is connected to the compressor suction nozzle and/or a compressor casing drain line, the suction scrubber being further connected, via a first check valve, to the drain storage tank for collecting the drain liquid in the drain storage tank. The intermittently pressurizing device is adapted to intermittently pressurize the drain storage tank to intermittently blow the drain liquid out of the drain storage tank through the suction line.

### CROSS REFERENCE TO RELATED APPLICATIONS

This application is the US National Stage of International Application No. PCT/EP2010/052414, filed Feb. 25, 2010 and claims the benefit thereof. The International Application claims the benefits of European application No. 09003448.9 EP filed Mar. 10, 2009. All of the applications are incorporated by reference herein in their entirety.

### FIELD OF INVENTION

The invention relates to a drain liquid relief system for a subsea compressor and a method for draining the subsea compressor.

### BACKGROUND OF INVENTION

Subsea oil and gas production modules offer a more economical alternative to high cost platforms for the extraction of oil and gas from offshore deposits. These units supply gas separation and compression capabilities to deliver natural gas to onshore processing facilities via underwater lines. For gas compression purpose in the subsea oil and gas production modules a subsea compressor installation is provided which is designed to run continuously without maintenance for years. The subsea compressor installation comprises a turbo compressor which is driven by means of a variable speed electrical drive.

Normally gas supplied to the compressor contains liquid which is to be eliminated before entering the compressor in order not to damage the internal parts of the compressor. Therefore, the liquid is drained upstream of the compressor inlet and usually relieved into the discharge line of the compressor. For the drainage of the liquid a suction scrubber is provided which is exposed to the suction pressure of the compressor. Therefore, a drain liquid pump is provided in order to increase the drain liquid pressure up to discharge pressure level for relief into the discharge line. The drain liquid pump may be driven batch wise or continuously.

However, in order to avoid making the drain liquid pump to be a reliability bottle neck of the subsea oil and gas production module, the drain liquid pump is designed to run without maintenance for years. One possibility to increase reliability of the drain liquid pump is to provide the pump 100% redundant. As a consequence of this, the drain liquid pump has high acquisition and production costs. WO 2008/004883 A1 and WO 2008/004882 A1 describe a method of processing and separating a multiphase well effluent mixture using a gas liquid separator comprising a gas compressor and a liquid pump. Further, WO 2005/026497 A1 describes a subsea compression system comprising a separation vessel with a pump. Additionally, WO 03/033870 A1 discloses a multiphase fluid conveyance system comprising a slug catcher vessel comprising a gas compressor and an injector.

### SUMMARY OF INVENTION

It is an object of the invention to provide a drain liquid relief system for a subsea compressor and a method for draining the subsea compressor, wherein the drain liquid relief system is robust, has low acquisition and production costs and is reliable in operation.

According to the invention the drain liquid relief system for a subsea compressor comprises a drain storage tank for collecting drain liquid contaminating the compressor flow in the drain storage tank, as well as an intermittently pressurizing device and a suction line connected to the bottom of the drain storage tank, wherein the intermittently pressurizing device is adapted to intermittently pressurize the drain storage tank in order to intermittently blow the drain liquid out of the drain storage tank through the suction line. Further, according to the invention a method for draining the subsea compressor comprises the steps: Providing the drain liquid relief system; Continuously collecting drain liquid contaminating the compressor flow in the drain storage tank; Intermittently pressurizing of the drain storage tank by the intermittently pressurizing device, in order to intermittently blow the drain liquid out of the drain storage tank through the suction line

The drain storage tank is emptied by means of the intermittently pressurizing device intermittently blowing the drain liquid out of the drain storage tank through the suction line. Consequently, for example a separate drain liquid pump, is not necessarily to be provided. Therefore, the inventive drain liquid relief system has low acquisition as well as production costs and is reliable in operation, and has additionally a robust design for subsea drain liquid relief.

It is preferred that the intermittently pressurizing device comprises a Venturi tube connected to a compressor discharge nozzle, a first check valve connecting the drain storage tank to a compressor suction nozzle, as well as a second check valve in the suction line being connected to a Venturi tube suction port, and a pressure switching device being adapted to pressurise the drain storage tank to the compressor suction pressure when the current drain liquid level in the drain storage tank is lower than a predetermined level so that the drain storage tank is to be filled with the drain liquid from the compressor suction nozzle, and to the compressor discharge pressure when the current drain liquid level in the drain storage tank is higher than the predetermined level so that the drain liquid in the drain storage tank is delivered to the Venturi tube suction port and therefore to the compressor discharge flow, since the Venturi tube suction port pressure is lower than the compressor discharge pressure.

In the drain liquid relief system, draining is done batch wise by opening and closing the control valve between the compressor discharge nozzle and the drain storage tank. The check valves prevent backflow into the suction region. When the compressor discharge flow passes the Venturi tube, a differential pressure is generated at the Venturi tube suction port by use of the Venturi principle.

It is preferred that the pressure switching device comprises a control valve being connected to the compressor discharge nozzle and being controlled by a level switch provided at the drain storage tank such that, when the level switch detects the current drain liquid level as being higher than the predetermined level, the control valve is open, and, when the level switch detects the current drain liquid level as being lower than the predetermined level, the control valve is shut. Further, preferably the pressure switching device comprises a three way valve being connected to the control valve, the drain storage tank and the compressor suction nozzle, such that, when the control valve is open and therefore applies the compressor discharge pressure to the three way valve, the three way valve connects the drain storage tank to the compressor discharge nozzle, and, when the control valve is shut, the three way valve connects the drain storage tank to the compressor suction nozzle. Furthermore, the Venturi tube is preferably integrally formed in the compressor discharge nozzle, or, as an alternative, it is preferred that the Venturi tube is fitted into a compressor discharge piping as a separate component.

According to the invention, the drain liquid relief system comprises a suction scrubber, which is connected to the compressor suction nozzle and/or a compressor casing drain line as well as via the first check valve to the drain storage tank for collecting the drain liquid in the drain storage tank. Further, the compressor casing drain line comprises preferably a control valve controlled by a level switch for discharging drain liquid from the compressor casing into the suction scrubber.

Additionally, it is preferred that the intermittently pressurizing of the drain storage tank by the intermittently pressurizing device is controlled by the current drain level in the drain storage tank in such a manner that, when the current drain level is at its predetermined minimum, the blowing out of the drain storage tank stops and the drain storage tank is filled with drain liquid until the current drain level reaches its predetermined maximum, and, when the current drain level is at its predetermined maximum, the blowing out of the drain storage tank starts and the drain storage tank is emptied from drain liquid until the current drain level reaches its predetermined minimum.

### BRIEF DESCRIPTION OF THE DRAWINGS

In the following the invention is explained on the basis of a preferred embodiment of the invention with reference to the drawings. In the drawings

FIG. 1 shows the preferred embodiment of the inventive drain liquid relief system, and

FIG. 2 shows a common drain liquid relief system.

### DETAILED DESCRIPTION OF INVENTION

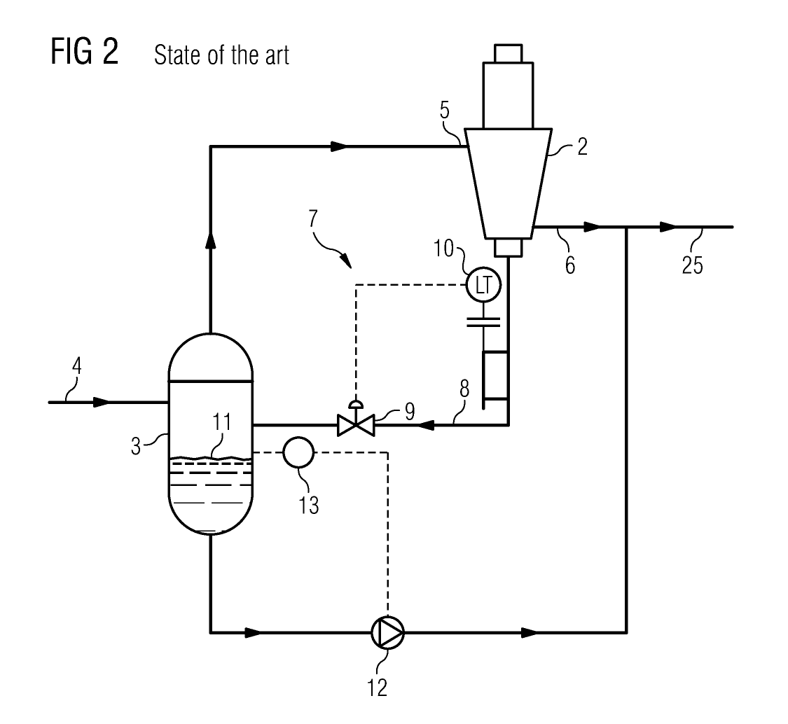

According to FIG. 2, a common drain liquid relief system for a subsea compressor 2 comprises a suction scrubber 3 which is installed between an inflow line 4 supplying feed gas and a suction nozzle 5 of the compressor 2. The compressed gas is discharged from the compressor 2 through a compressor discharge nozzle 6. At the compressor suction nozzle 5 the gas is under a suction pressure, and at the compressor discharge nozzle 6 the gas is under a discharge pressure, wherein the suction pressure is lower than the discharge pressure. In the suction scrubber 3 liquid contaminating the feed gas is eliminated and collected.

The compressor 2 is provided with a compressor casing drain system 7 comprising a compressor casing drain line 8 delivering additional drain liquid from the compressor 2 to the suction scrubber 3. In order to control the drain liquid flow in the compressor casing, in the drain liquid line 8 a first control valve 9 is provided which is controlled by means of a level switch 10 sensing the drain liquid level in the compressor casing drain liquid line 8. When the current drain liquid level in the compressor casing drain liquid line 8 is high, the first level switch 10 opens the first control valve 9 in order to collect the drain liquid in the suction scrubber 3. The current liquid volume collected in the suction scrubber is defined by a current drain level 11.

During operation of the compressor 2, continuously drain liquid is collected in the suction scrubber 3. Therefore, at least from time to time the suction scrubber 3 needs to be emptied from the drain liquid in order not to generate an overflow of the suction scrubber 3. To this end at the bottom of the suction scrubber 3 a drain pump 12 is provided, wherein the discharge of the drain pump 12 is connected to the compressor discharge nozzle 6 so that by operating the drain pump 12 the drain liquid from the suction scrubber 3 is pressurised from the suction pressure to the discharge pressure and delivered to the compressor discharge nozzle 6. For controlling the drain pump 12 a second level switch 13 is provided sensing the current drain liquid level 11 in the suction scrubber 3. In case the drain liquid level 11 in the suction scrubber 3 exceeds a predetermined level, the second level switch 13 activates the drain pump 12 for discharging the drain liquid from the suction scrubber 3 to the compressor discharge nozzle 6.

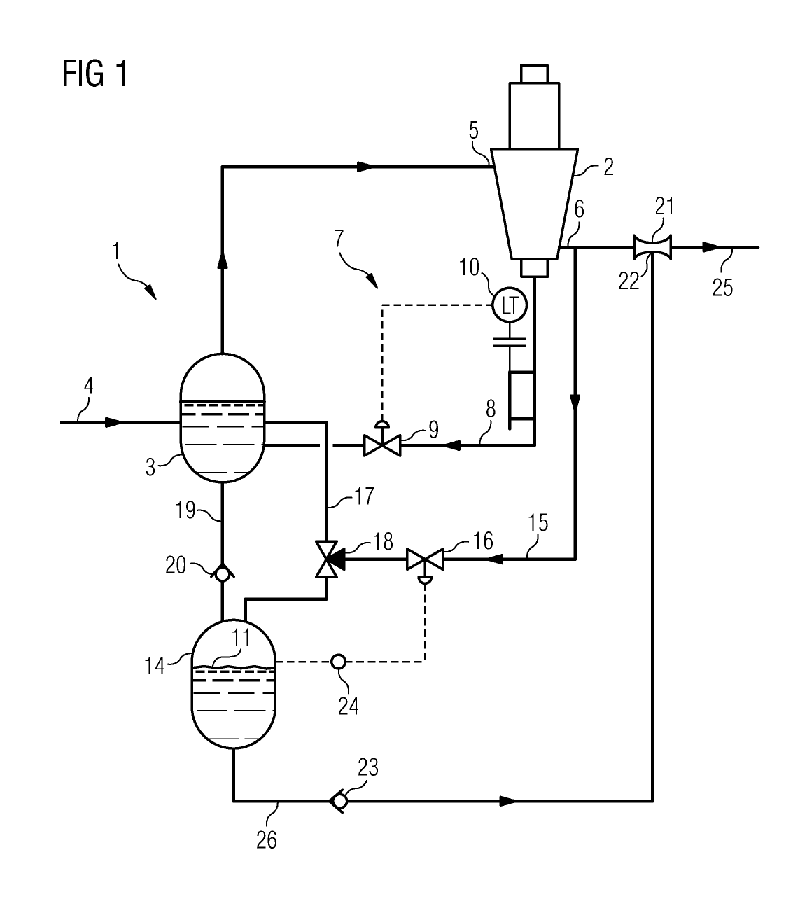

FIG. 1 shows a drain liquid relief system 1 according to the invention. The inventive drain liquid relief system 1 differs from the common drain liquid relief system according to FIG. 1 in that the drain pump 12 and the second level switch 13 are not provided as well as the inventive drain liquid relief system 1 comprises in particular a drain storage tank 14 and a Venturi tube 21. The Venturi tube 21 is connected to the compressor discharge nozzle 6 and is operated by the compressor discharge flow for generating a pressure lower than the discharge pressure in the drain storage tank 14 in order to deliver the drain liquid from the drain storage tank 14 to the compressor discharge nozzle 6.

A reverse line 15 is connected to the compressor discharge nozzle 6 and comprises a second control valve 16. A coupling line 17 is connected via a three way valve 18 to the second control valve 16 as well as the suction scrubber 3 and the drain storage tank 14. The drain storage tank 14 is arranged underneath the suction scrubber 3 and is connected to the bottom of the suction scrubber 3 my means of a liquid line 19 including a first check valve 20. The Venturi tube 21 comprises a Venturi tube suction port 22 and discharges its throughflow into a discharge piping 25. The Venturi tube suction port 22 is connected to the bottom of the drain storage tank 14 by a suction line 26 comprising a second check valve 23. At the drain storage tank 14 a third level switch 24 is provided sensing the current drain liquid level 11 in the drain storage tank 14 and controlling the second control valve 16.

Provided that during operation of the compressor 2 the current drain liquid level 11 in the drain storage tank 14 is below a predetermined level. The third level switch 24 is adapted to detect such level constellation and, as a consequence of this, changes the setting of the second control valve 16 to be shut. As a result of this, the second control valve 16 switches the three way valve 18 in that the connection between the suction scrubber 3 and the drain storage tank 14 by the coupling line 17 is open, whereas the reverse line 15 is disconnected from the coupling line 17. Therefore, through the coupling line 17 the drain storage tank 14 is pressurised to the suction pressure applied in the suction scrubber 3. As a consequence of this, the first check valve 20 opens and drain liquid is delivered from the suction scrubber 3 into the drain storage tank 14 through the liquid line 19. Such filling of the drain storage tank 14 with drain liquid is continued until the predetermined level is reached in the drain storage tank 14.

The third level switch 24 is adapted to detect the current drain level 11 in the drain storage tank 14 to be higher than the predetermined level and, as a consequence of this, change the setting of the second control valve 16 to be open. Before opening of the control valve 16 the three way valve 26 is brought in a setting in which the coupling line 17 is disconnected and the reverse line 15 is connected to the drain storage tank 14. As a result of this, the pressure in the drain storage tank 14 increases, since the drain storage tank 14 is connected to the compressor discharge nozzle 6. When the pressure in the drain storage tank 14 is higher than the pressure in the suction scrubber 3, the first check valve 20 shuts so that no more drain liquid can flow from the suction scrubber 3 into the drain storage tank 14. Since the drain storage tank 14 is connected to the compressor discharge nozzle 6 and is isolated from the suction scrubber 3, the pressure in the drain storage tank 14 increases up (near) to the level of the discharge pressure.

The compressor discharge flow flows through the Venturi tube and therefore, due to the Venturi principal at the Venturi tube suction port 22, a pressure is applied which is lower than the compressor discharge pressure. At the time when in the drain storage tank 14 the pressure is higher than the pressure at the Venturi tube suction port 22, the second check valve 23 opens and drain liquid flows from the drain storage tank 14 through the suction line 26 to the Venturi tube and then into the discharge piping 25. During that the current drain level 11 in the drain storage tank 14 is brought lower. When the current drain level 11 has reached the predetermined level the third level switch 24 detects such level constellation and activates the second control valve 16 in order to be shut. Then the tree way valve 18 connects again the suction scrubber 3 and the drain storage tank 14 to be filled with drain liquid from the suction scrubber 3 again. By means of the described cycle a batch wise draining of the compressor 2 is performed.

1.-9. (canceled)

10. A drain liquid relief system for a subsea compressor, comprising:
a suction scrubber a drain storage tank for collecting drain liquid contaminating the compressor flow in the drain storage tank;
an intermittently pressurizing device and a suction line connected to the bottom of the drain storage tank;
wherein the suction scrubber is connected to the compressor suction nozzle and/or a compressor casing drain line, the suction scrubber being further connected, via a first check valve, to the drain storage tank for collecting the drain liquid in the drain storage tank, and
wherein the intermittently pressurizing device is adapted to intermittently pressurize the drain storage tank to intermittently blow the drain liquid out of the drain storage tank through the suction line.

11. The drain liquid relief system according to claim 10, wherein the intermittently pressurizing device comprises:
a Venturi tube connected to a compressor discharge nozzle,
the first check valve connecting the drain storage tank to the compressor suction nozzle,
a second check valve in the suction line being connected to a Venturi tube suction port, and
a pressure switching device adapted to:
pressurize the drain storage tank to the compressor suction pressure when the current drain liquid level in the drain storage tank is lower than a predetermined level so that the drain storage tank is to be filled with the drain liquid from the compressor suction nozzle, and
pressurize the drain storage tank to the compressor discharge pressure when the current drain liquid level in the drain storage tank is higher than the predetermined level so that the drain liquid in the drain storage tank is delivered to the Venturi tube suction port and therefore to the compressor discharge flow, since the Venturi tube suction port pressure is lower than the compressor discharge pressure.

12. The drain liquid relief system according to claim 11, wherein the pressure switching device comprises a control valve being connected to the compressor discharge nozzle and being controlled by a level switch provided at the drain storage tank, such that:
when the level switch detects the current drain liquid level as being higher than the predetermined level, the control valve is open, and
when the level switch detects the current drain liquid level as being lower than the predetermined level, the control valve is shut.

13. The drain liquid relief system according to claim 12, wherein the pressure switching device comprises a three way valve connected to the control valve, the drain storage tank and the compressor suction nozzle, such that:
when the control valve is open to resultantly apply the compressor discharge pressure to the three way valve, the three way valve connects the drain storage tank to the compressor discharge nozzle, and,
when the control valve is shut, the three way valve connects the drain storage tank to the compressor suction nozzle.

14. The drain liquid relief system according to claim 11, wherein the Venturi tube is integrally formed in the compressor discharge nozzle.

15. The drain liquid relief system according to claim 11, wherein the Venturi tube is fitted into a compressor discharge piping as a separate component.

16. The drain liquid relief system according to claim 10, wherein the compressor casing drain line comprises a control valve controlled by a level switch for discharging drain liquid from the compressor casing into the suction scrubber.

17. A method for draining a subsea compressor, comprising the steps:
providing a drain liquid relief system, the drain liquid relief system comprising a suction scrubber and a drain storage tank for collecting drain liquid contaminating the compressor flow in the drain storage tank, as well as an intermittently pressurizing device and a suction line connected to the bottom of the drain storage tank, wherein the suction scrubber is connected to the compressor suction nozzle and/or a compressor casing drain line and is further connected, via a first check valve, to the drain storage tank for collecting the drain liquid in the drain storage tank, the intermittently pressurizing device being adapted to intermittently pressurize the drain storage tank in order to intermittently blow the drain liquid out of the drain storage tank through the suction line;
continuously collecting drain liquid contaminating the compressor flow in the drain storage tank; and
intermittently pressurizing of the drain storage tank by the intermittently pressurizing device, in order to intermittently blow the drain liquid out of the drain storage tank through the suction line.

18. The method according to claim 17, wherein the intermittently pressurizing of the drain storage tank by the intermittently pressurizing device is controlled by the current drain level in the drain storage tank in such a manner that:
when the current drain level is at its predetermined minimum, the blowing out of the drain storage tank stops and the drain storage tank is filled with drain liquid until the current drain level reaches its predetermined maximum, and
when the current drain level is at its predetermined maximum, the blowing out of the drain storage tank starts and the drain storage tank is emptied from drain liquid until the current drain level reaches its predetermined minimum.
